(19) United States
(12) Patent Application Publication
(10) Pub. No.: US 2017/0122034 A1
(43) Pub. Date: May 4, 2017

(54) Turbine Assembly for use in a Downhole Pulsing Apparatus

(71) Applicant: Cauldron Oil Tools, LLC, Houston, TX (US)

(72) Inventors: Rick Nichols, Humble, TX (US); Aref Alali, Humble, TX (US); Colin Donoghue, Humble, TX (US)

(21) Appl. No.: 15/167,376

(22) Filed: May 27, 2016

Related U.S. Application Data
(63) Continuation-in-part of application No. 14/930,346, filed on Nov. 2, 2015.

(51) Int. Cl. E21B 6/02; E21B 21/10; F01D 15/00; F01D 5/06; F01D 9/04; F01D 25/24; E21B 4/02; E21B 7/24

(52) U.S. Cl. CPC E21B 6/02; E21B 4/02; E21B 21/10; E21B 7/24; F01D 5/06; F01D 9/041; F01D 25/24; F01D 15/00; F05D 2220/70

(57) ABSTRACT

A downhole pulsing apparatus having a tubular housing, a first valve assembly positioned in the housing, first and second turbine stages each comprising a stator and a rotor positioned in the housing below the first valve assembly and a second valve assembly positioned in the housing. There is a tubular mandrel connected for rotation of the rotors of the turbine stages and to a second valve assembly. The first valve assembly includes a valve element which is movable between a first position wherein pressurized fluid flow entering the housing is directed to the first turbine assembly, and a second position wherein the fluid flow is directed primarily axially through the apparatus so as to partially bypass the first turbine stage.

### CROSS-REFERENCE TO RELATED APPLICATION

This application claims priority to U.S. application Ser. No. 14/930,346 filed on Nov. 2, 2015, the disclosure of which is incorporated herein by reference for all purposes.

### FIELD OF THE INVENTION

The present invention relates to a fluid pulsing apparatus for use in various applications such as in downhole operations in oil/gas wells and to a turbine assembly that can be used in such a pulsing apparatus.

### BACKGROUND OF THE INVENTION

In the drilling of oil and gas wells as well as other downhole activities, it is common to use a downhole system which provides a percussive or hammer effect to the drill string to increase drilling rate and/or minimize sticking of the drill string in the borehole. In typical drilling operations, a drilling fluid or mud is pumped from the surface, through the drill string and exits through nozzles in the drill bit. The fluid flow from the nozzles assists in dislodging and cleaning cuttings from the bottom of the borehole as well as carrying the cuttings back to the surface.

Pulsing apparatuses for wellbore activities are well known as exemplified by U.S. Pat. Nos. 2,743,083; 2,780,438; 5,190,114; and 6,279,670. In general, the flow pulses are achieved by periodically restricting flow to produce pressure pulses. The pressure pulses are translated along the drill string causing the drill string to vibrate in a longitudinal direction, the net result being a percussive effect along the length of the drill string.

It is also common in addition to using the pulsing apparatus to incorporate a pressure-responsive tool in the drill string which expands or retracts in response to the varying fluid pressure pulses created by operation of the pulsing apparatus. This expansion/retraction motion provides the desired percussive effect at the drill bit. Such an apparatus may be in the form of a shock sub or tool and, may be provided above or below the pulsing apparatus or in certain cases can form part of a pulsing apparatus.

Turbines are used as drive systems in a variety of applications and as is well known, generally each stage of a turbine comprises a stator and a rotor. A typical turbine also includes a rotatable output shaft connected to the rotors of the various stages. To function effectively, it is desired that the torque and speed of the output shaft be controlled. Generally, in a multi-stage turbine, the first stage is aggressive so as to generate sufficient torque to overcome the inertia in the rotors of the downstream stages. However, the initial high torque generated in the first stage can pose a problem in controlling the torque and speed of the output shaft. To alleviate this problem, the downstream stages can be designed to be less aggressive. However, there is a tradeoff between a less aggressive design and the number of stages that may be required to control the torque and speed of the output shaft.

### SUMMARY OF THE INVENTION

In one aspect, the present invention provides a downhole pulsing apparatus which can be used to impart periodic, longitudinal movement in a drill string.

In another aspect, the present invention provides a pulsing apparatus wherein fluid flow through the apparatus can be modulated to control the fluid flow pattern through the pulsing apparatus.

In still a further aspect, the present invention provides a turbine driving system.

These and further features and advantages of the present invention will become apparent from the following detailed description, wherein reference is made to the figures in the accompanying drawings.

### BRIEF DESCRIPTION OF THE DRAWINGS

FIG. 1A is an elevational view, partly in section, showing the first, upper end of one embodiment of the pulsing apparatus of the present invention.

FIG. 1B is an elevational view, partly in section showing another portion of the pulsing apparatus of the present invention.

FIG. 1C is a view similar to FIG. 1B showing another portion of the pulsing apparatus of the present invention.

FIG. 1D is an elevational view, partly in section, of another portion of the pulsing apparatus of the present invention.

FIG. 2 is a view similar to FIG. 1A but showing the pulsing apparatus having been activated.

FIG. 3 is a view taken along the lines 3-3 of FIG. 1D.

FIG. 4 is a view taken along the lines 4-4 of FIG. 1D.

FIG. 5 is an enlarged, elevational showing the lower valve assembly employed in the pulsing apparatus of the present invention.

### DETAILED DESCRIPTION OF PREFERRED EMBODIMENTS

While the invention will be described with respect to its use in a drill string preferably having a downhole motor, it will be understood that it is not so limited. It can be used in other downhole operations, e.g., drilling with tubulars, or in any other downhole operation involving a downhole string through which fluid is flowing. Thus, the pulsing apparatus of the present invention can be used in work strings, fracking operations, etc.

The turbine of the present invention can be used to extract energy from the flowing fluid and converted into work, e.g., by affixing the shaft of the turbine to a piece of rotary machinery such as a compressor.

The term “turbine stage” as used herein comprises at least one stator assembly and at least one rotor assembly.

As used herein and with respect to the pulsing apparatus of the present invention, the terms “upper,” “lower,” “up,” “down,” and similar terms are with reference to the orientation of the apparatus in a borehole. In this regard, in a deviated well wherein the borehole has a generally vertical section and a generally horizontal section, and assuming the pulsing apparatus is in the horizontal section of the borehole, the end of the pulsing apparatus closed to the vertical section of the borehole would be considered the upper end/up, etc.

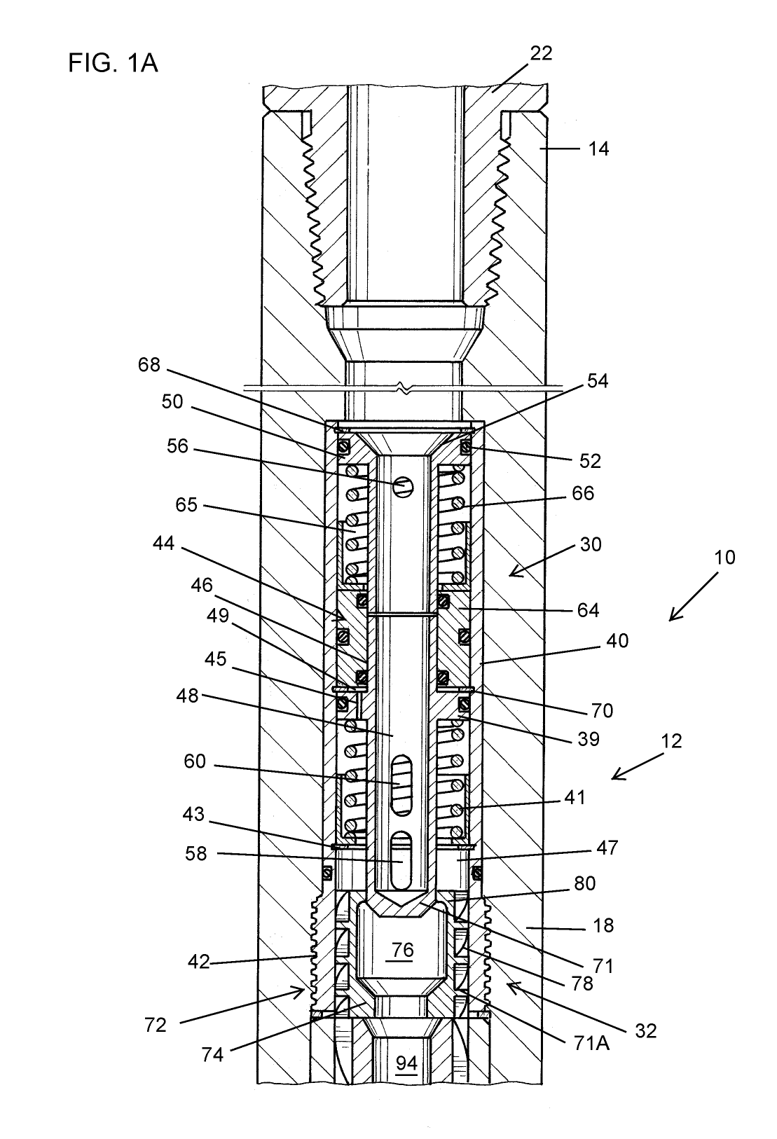

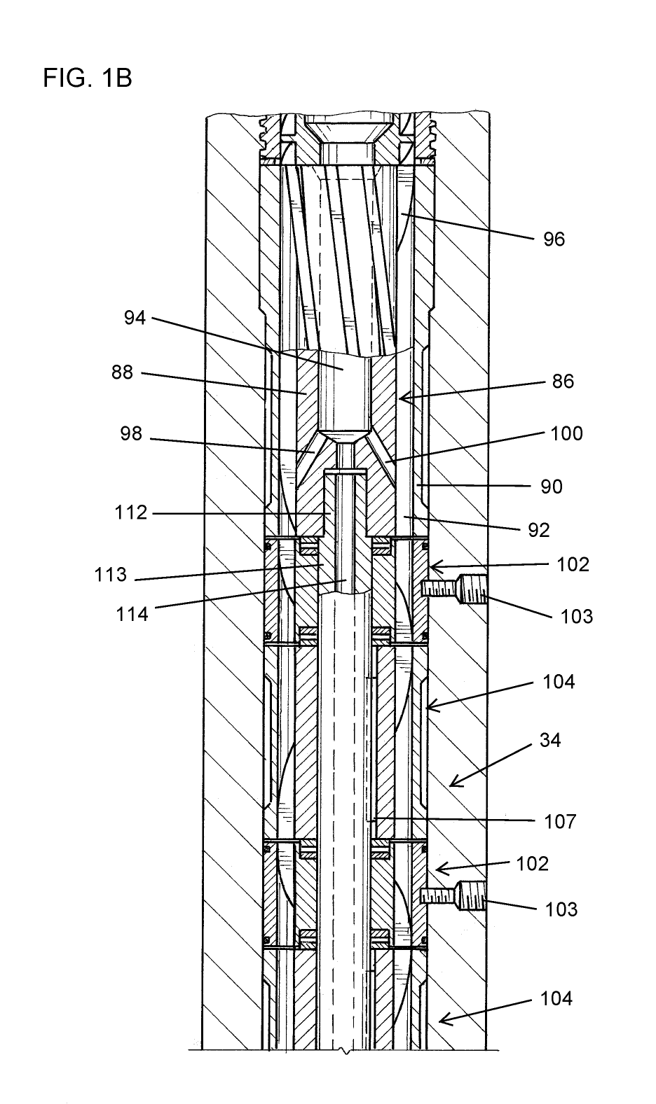

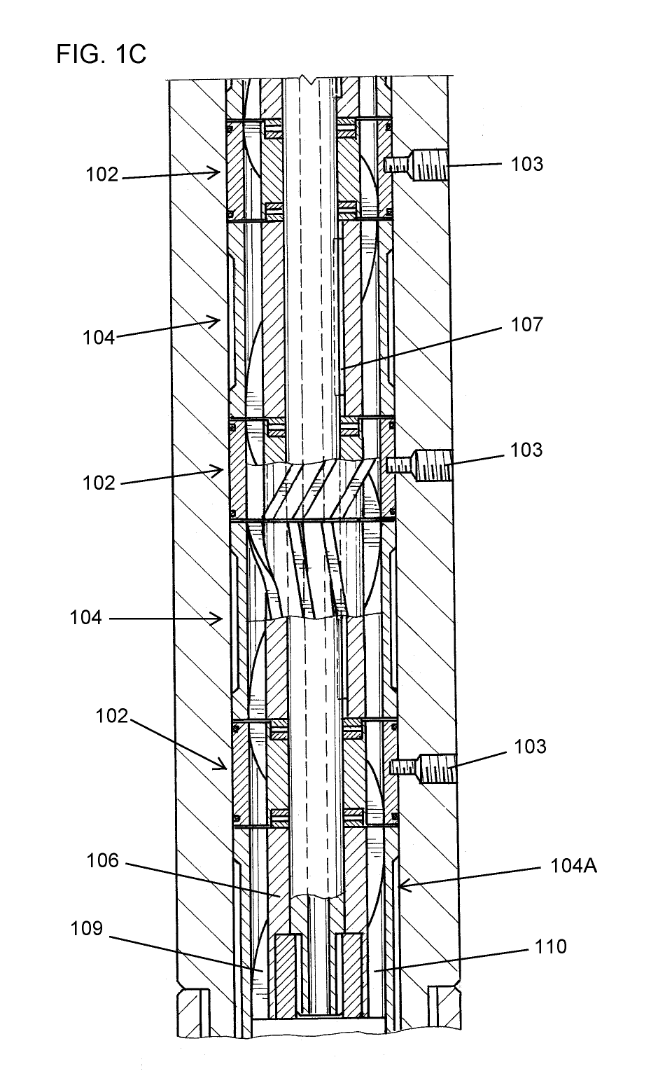

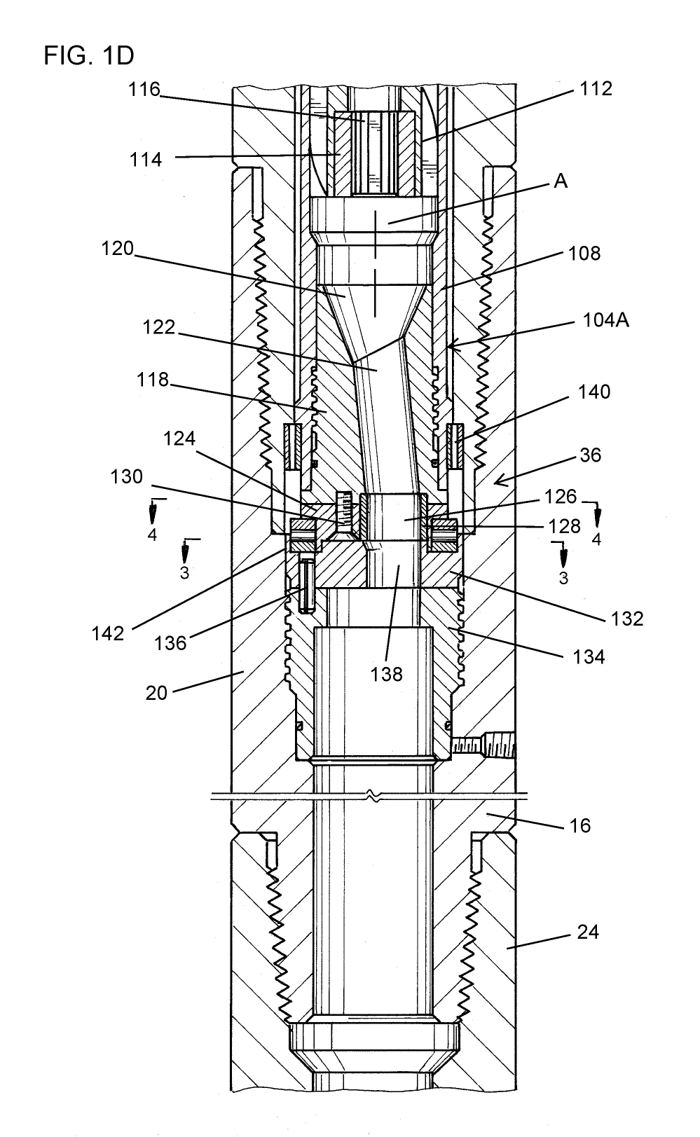

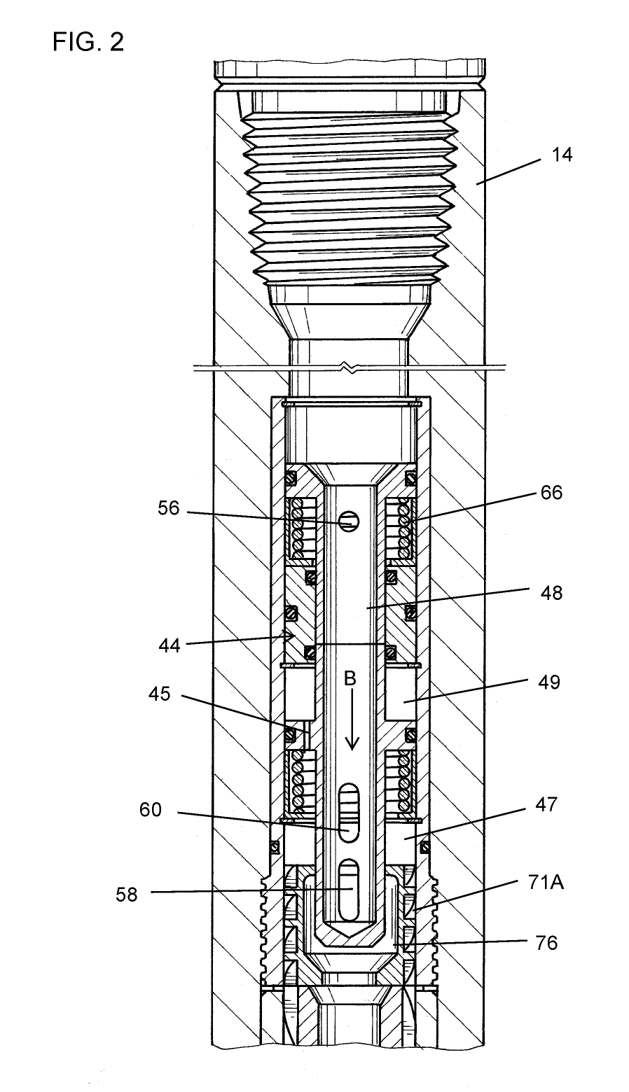

Turning then to FIGS. 1A and 2, the pulsing apparatus, shown generally as 10 comprises a tubular housing shown generally as 12 having a first or upper end 14. As shown in FIG. 1D, housing 12 also has a second or lower end 16. Housing 12 comprises two threadedly connected subs, 18 and 20 (see FIG. 1D). Sub 18 is connected at its upper end 14 to a drill string element 22 which can be a portion of the drill string, a sub, another tool, etc. Lower sub 16, as shown in FIG. 1D, is threadedly connected to a drill string 24.

Pulsing apparatus 10 comprises a first valve assembly shown generally as 30 (see FIGS. 1A and 2), a first turbine stage (FIGS. 1A and 2) positioned below first valve assembly 30 and shown generally as 32, a plurality of downstream intermediate turbine stages 34 (see FIGS. 1B and 1C), and a second valve assembly shown generally as 36 (see FIG. 1D).

Referring now to FIG. 1A, valve assembly 30 comprises a tube 40 threadedly secured to the interior of housing 12 as shown at 42. Reciprocally mounted in tube 40 is a valve element or plunger shown generally as 44, plunger 44 having a hollow stem 46 having an axial bore 48 therein. Plunger 44 also includes a head a portion comprised of an annular, radially outwardly extending flange 50, there being an o-ring 52 between the flange 50 and the inner wall of tube 40. The head portion of plunger 44 has an annular, axially facing, funnel shaped surface 54 which serves as a piston surface or head and as a mouth leading into bore 48. Plunger 44 also has a nose portion 71 formed on the lower end. There is a radial bleed port 56 through stem 46, generally proximal head portion 50 of valve element 44, and first and second apertures 58 and 60, aperture 60 being disposed between aperture 58 and bleed port 56.

Disposed in an annulus between tube 40 and stem 46 is a sleeve 64, sleeve 64 being sealingly engaged with the inner wall of tube 40 and slidingly, sealingly engaged with stem 46. Formed between sleeve 64 and the flange 50 of plunger 44 is a spring chamber 65, a compression spring 68 being disposed in spring chamber 66, spring 68 engaging flange 50 and the upper end of sleeve 64. As seen, sleeve 64 and head portion 50 are held in tube 40 by means of upper and lower snap rings 68 and 70, respectively. It can thus be seen that bleed port 56 provides open communication between bore 48 in stem 46 and spring chamber 66.

There is a second annular, radially outwardly extending flange 39 formed on plunger 44, flange 39 being axially spaced from flange 50. Compression spring 41 is held between flange 39 a snap ring 43, an annular space 47 being formed in surrounding relationship to stem 46. An axially extending restricted port 45 is formed through flange 39 and provides open communication between annular space 47 and a chamber 49 formed between sleeve 64 and flange 39. Plunger 44 has a nose portion 71 formed on its lower end. Disposed in the lowermost end of tube 40 is a stator assembly shown generally as 72, stator assembly 72 having a body portion 74 having a through bore forming a stator cavity 76. Stator assembly 72 also includes fixed, circumferentially spaced, radially outwardly extending angled vanes 78 through which extends an annular flowway 71A. Stator body 74 has an opening 80 in open communication with cavity 76 through which stem 46 of plunger 44 is snugly but slidingly received. As best shown in FIG. 1B, positioned in housing 12 below stator 72 is a rotor assembly shown generally as 86, rotor assembly 86 comprising a central core or body portion 88 and an annular radially outwardly displaced annular sleeve 90, core 88 and sleeve 90 forming an annular flow path 92 therebetween. A series of circumferentially spaced angled rotor vanes 96 interconnect core 88 with sleeve 90 and are positioned in annulus 92.

Rotor body 88 has a central flow path 94 which is in open communication with the through bore in stator body 74. Central flow path 94 is in turn in open communication with annular flow path 92 via angled ports 98 and 100. As best seen in FIG. 1B, the upper end 112 has a longitudinally extending mandrel 113 having a passageway 114 extending axially therethrough is connected to rotor body 88, with passageway 114 being in open communication with central flowpath 94 through rotor body 88. It will thus be understood that as rotor assembly 86 rotates, mandrel 113 rotates therewith.

Referring now to FIGS. 1B and 1C there can be seen four additional intermediate turbine stages, each of which is comprised of a stator assembly 102 secured to housing 12 by means of set screws 103 and a rotor assembly 104 rotatably journaled in housing 12. It will be understood that each of the rotor assemblies 104 are connected to mandrel 113 for rotation therewith by means of a spline connector 107. While as shown, the assembly comprises the four additional, intermediate turbine stages, it will be understood that fewer or more intermediate turbine stages can be employed if desired.

There is a terminal turbine stage comprised of stator assembly 102 and a rotor assembly 104A. Rotor assembly 104A comprises a body or core portion 106 and a radially outwardly displaced annular sleeve 108 forming an annular flow path 110 therebetween, a plurality of angled vanes or blades 109 being interconnected to core portion 106 and sleeve 108 and disposed in annulus 110. As seen in FIGS. 1C and 1D, core portion 106 has a socket 112 in which is press fitted an internally splined bushing 114, the splines on bushing 114 engaging splines 116 on the lower end of mandrel 113.

An externally threaded fitting 118 is threadedly received in the lower end of sleeve 108. Sleeve 108 has a funnel shaped mouth 120 communicating with an angled flowway 122. There is a first valve plate or disc 124 having an offset opening 126 defined by a carbide wear bushing 128, opening 126 being in open communication with flowway 122. Disc 124 is connected to fitting 118 by means of a bolt 130. A fixed valve plate 132 is connected to a threaded fitting 134 by means of a slotted pin 136 received in registering holes in plate 132 and fitting 134. Fixed valve plate 132 has an opening 138 which in the position shown in FIG. 1D is in register with opening 126 in rotating valve plate 124. Rotor assembly 104 A is rotatably journaled in housing 12 by radial needle bearing assemblies 140 and thrust needle bearing assemblies 142.

The operation of the pulsing apparatus of the present invention can best be understood by reference to FIGS. 1A and 2. FIG. 1A depicts the pulsing apparatus in a condition wherein there is static fluid pressure in the drill string i.e., the pumps are in the off position. In this condition, bore 48 of plunger 44 is full of fluid as is chamber 65. Furthermore, there is a fully open fluid flow path to annular flowway 71A via aperture 58 and annular space 47. When the pumps are turned on, pressurized fluid flows through bore 48, annular space 47, and into the annular flowway 71A through stator assembly 72. It should be noted that because of the slidable, albeit tight, clearance between the OD of stem 46 and the opening 80 in stator body 74, a minimal amount of pressurized fluid is flowing axially through the center of the tool, i.e., substantially all flow is through the annular flow paths of the first turbine stage. Preferably, the vanes 78 of stator 72 are designed to have a high attack angle. Pressurized fluid exiting the annular flow path 71 through the vanes 78 of the stator 74 contact vanes 90 of rotor assembly 86 with the result that the rotor assembly 86 begins rotating at a high speed and generating high torque. It should be noted that this initial high torque output by the first turbine stage is necessary to overcome the inertia of the downstream turbine stages so that they will begin rotating. However, if not modulated this high torque would result in excessive speed of the opening and closing of valve assembly 36. To effect this modulation, the valve assembly 30 has a unique delay system.

The flow of pressurized fluid acting on piston face 54 moves plunger 44 in the direction of arrow B. As plunger 44 is moving in the direction of arrow B, fluid initially trapped in chamber 65 is forced through bleed port 56 into bore 48 causing a delay as it slows the movement of plunger 44 in the direction of arrow B and allows, as described above, substantially full fluid flow through the first turbine assembly. Additionally, movement of the valve element 44 in the direction of arrow B also forces flange 39 downwardly compressing spring 41 and resulting in evacuation of chamber 49 through restricted flow path 45. This acts as a further delay. It should be noted that the forced release of fluid from chamber 65 and evacuation of chamber 49 occur simultaneously. As plunger 44 moves downwardly in the direction of arrow B, aperture 58 eventually moves into full register with cavity 76. Accordingly, while there is still some annular flow through the first turbine stage 32, the larger percentage of the pressurized fluid is diverted through the central flow path of the first stator into the central flowway of the first rotor and then through the annular flow path formed through the intermediate turbine stages via the ports 98 and 100. Once the flow is diverted from the first turbine stage 32 and directed to the downstream turbine stages, the torque output of the first turbine stage is reduced such that all stages can run at substantially the same controlled speed.

Thus, as can be seen from the above, the pulsing apparatus of the present invention has an axial fluid flow path, e.g., through the first turbine stage and mandrel 113 and an annular fluid flow path through the stators and rotors. While at all times during operation of the mud pumps, there is flow through the annular fluid flow path, flow through the axial fluid flow path only commences to any extent when plunger 44 is moved to the position shown in FIG. 2. In this regard, and as noted above, at this point, pressurized fluid flow through the annular flow path of the first turbine stage is reduced in favor of fluid flow through the axial flow path.

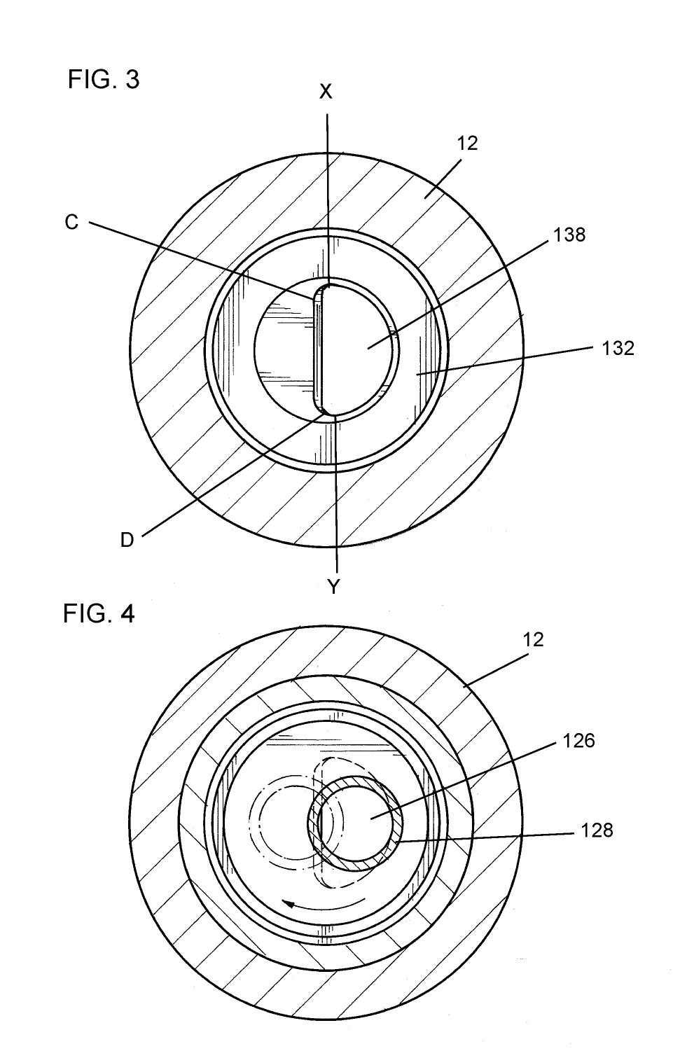

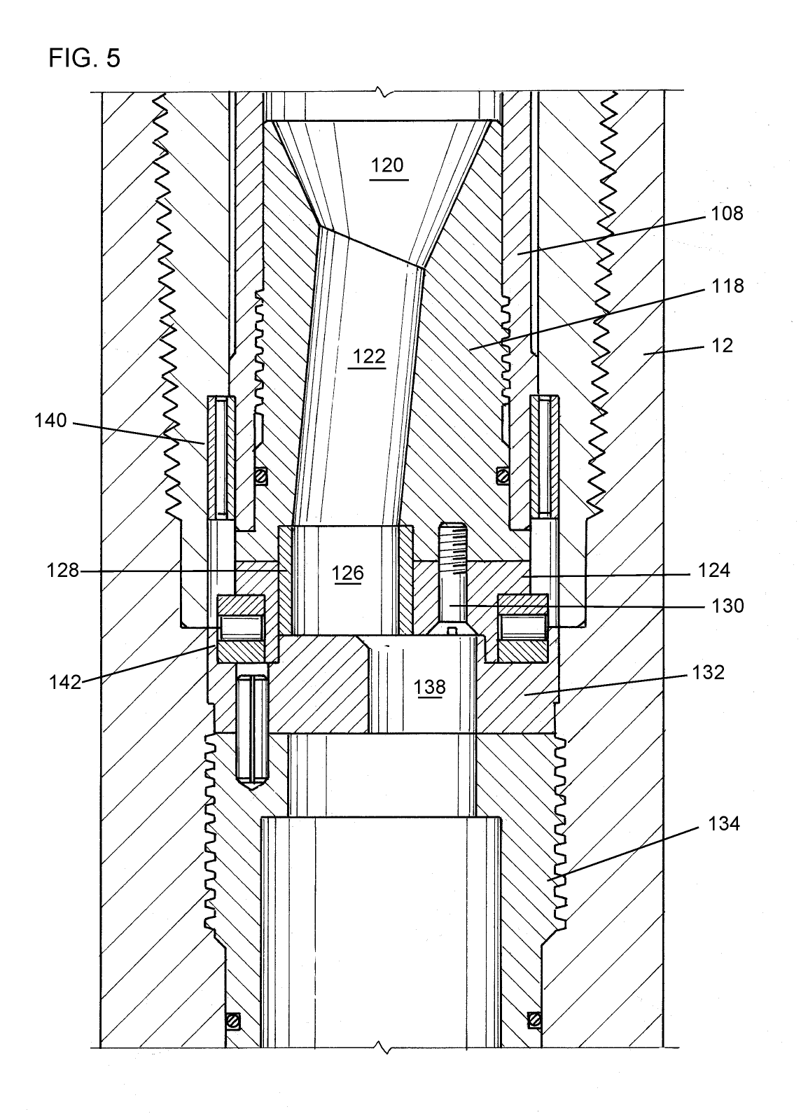

With respect to second valve assembly 36, reference is made to FIGS. 3-5. As best seen in FIG. 3, opening 138 is generally crescent-shaped. More specifically opening 138 has a modified crescent shape comprised of a generally semi-circular portion which extends from about point X to about point Y, a straight portion which extends from about point C to about point D, a first arc portion which extends between point A and point C and a second arc portion which extends between point B and point D. Opening 138 can also be described as bean-shaped, kidney-shaped, etc.

As can be best seen from FIGS. 3-5, at all times there is some overlap between opening 126 and eccentrically rotating opening 138. This ensures that at all times while the mud pumps are operating, there is fluid flow through the drill string. It will also be appreciated that as rotor assembly 104A rotates, the degree of overlap between openings 220 and 194 will vary, resulting in flow changes and hence pressure pulses of mud emanating from pulsing apparatus 10.

As noted above, the first turbine stage is aggressive. Thus, the first turbine stage stator blades have an angle of from about 40 to about 50 degrees while the angle of the vanes in the downstream stators are less aggressive and will be from about 0 to about 30 degrees. In the case of the rotors, including the first stage rotor, the angle of the vanes will generally vary from about 5 to about 10 degrees.

As noted above, there is a bleed port 56 and a restricted passage 45, both of which act in delaying fluid flow through the central flow passage of the tool. The diameter of the bleed port 56 will generally vary from about 1/16″ to about ⅜″, while the diameter of the restricted passage 45 will vary from about 1/16″ to about ⅜″. It is to be understood that the diameter of the bleed port 56 and of the restricted passage 45 can vary depending primarily on the spring force of the compression springs, the pressure and flow rate of the pressurized fluid, and the viscosity and weight of the fluid.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A downhole pulsing apparatus comprising:
an elongate tubular housing having a first upper end and a second lower end;
a first valve assembly positioned in said housing proximal said first end, said first valve assembly comprising:
a valve element reciprocally mounted in said housing, said valve element comprising an elongate stem having a first end forming a head portion, a second end, and a longitudinally extending bore, a radial bleed port formed in said body proximal said heat portion, a first radial aperture formed in said stem proximal said second end;
a first compression spring disposed in said housing for biasing said valve element to a first position;
a first chamber in surrounding relationship to said stem, said bleed port providing open communication between said chamber and said bore in said stem;
a first turbine stage comprising:
a first stator assembly positioned in said housing below said first valve assembly, said first stator assembly comprising a first stator body having a through bore forming a first stator cavity and a plurality of radially outwardly extending angled vanes attached to said first stator body, a first stator annular flow path being formed between said first stator body and said housing;
a first rotor assembly positioned in said housing below said first stator assembly, said first rotor assembly comprising a first rotor body having a first central flow path in open communication with said through bore and a first rotor annular flow path in open communication with said first stator annular flow path, a plurality of radially outwardly extending angled first rotor vanes connected to said first rotor body and disposed in said first rotor annular flow path, whereby fluid flow from said first stator annular flow path impinges on said first rotor vanes;
a tubular mandrel having a first end, a second end, and an axial passageway therethrough, said passageway being in open communication with said central flow path through said first rotor assembly, said first end of said mandrel being connected to said first rotor assembly for rotation therewith;
a second turbine stage positioned in said housing below said first turbine stage, said second turbine stage comprising a second stator body having a central bore therethrough, said second stator body being fixed to said housing, said second turbine stage further comprising a second rotor body having a central bore therethrough, said mandrel extending through said central bore in said second stator body and said second rotor body, said second rotor body being connected to said mandrel for rotation therewith;
a second valve assembly disposed in said housing and connected to said second end of said mandrel, said second valve assembly being movable between a first partially open position and a second fully open position in response to rotation of said mandrel,
whereby pressurized fluid acting on said valve element in a first position initially flows through said annular flow path of said first turbine stage, continued application of said pressurized fluid moving said valve element to a second position compressing said first spring and forcing fluid in said first chamber through said bleed port into said bore and moving said first aperture in register with said stator cavity, thereby diverting at least a portion of said pressurized fluid flow from said first turbine stage to said first stator cavity.

2. The apparatus of claim 1, wherein said valve assembly further comprises an elongate tube having a first tube end and a second tube end, said valve element being reciprocally received in said elongate tube.

3. The apparatus of claim 2, wherein said head portion of said valve element comprises a first radially outwardly extending flange and an annular axially facing piston surface forming a mouth of said bore.

4. The apparatus of claim 3, wherein there is a second annular radially outwardly extending flange formed on said stem and axially spaced from said first flange, an annular space in surrounding relationship to said stem being formed in said tube between said second flange and said first stator body.

5. The apparatus of claim 4, wherein there is a spring stop disposed in said annular space and a second compression spring disposed between said second flange and said spring stop.

6. The apparatus of claim 4, wherein there is an axially extending passage formed through said second flange.

7. The apparatus of claim 6, wherein there is an annular seal between said second flange and said tube, a radially innermost annular seal between said sleeve and said tube, and a radially outermost annular seal between said sleeve and said tube, a variable volume chamber being formed between said sleeve and said second flange, said axially extending passage in said second flange being in open communication with said variable volume chamber whereby as said valve element moves to said second position, pressure in said variable volume chamber is reduced as said variable volume chamber increases in volume.

8. The apparatus of claim 4, wherein there is a second radial aperture formed in said stem between said first aperture and said first end of said stem, at least a portion of said second aperture being in register with said annular space wherein said valve element is in said second position.

9. The apparatus of claim 1, wherein said first rotor body comprises a central core portion in surrounding relationship to said central flow path and therein an outer first rotor sleeve, a first rotor annulus being formed between said central core portion and said first outer sleeve, said first rotor vanes being disposed in said first rotor annulus and interconnected to said central core portion and said first outer sleeve.

10. The apparatus of claim 9, further comprising a plurality of angled ports in said central core portion said angled ports providing open communication between said central flow path and said first rotor annulus.

11. The apparatus of claim 1, wherein said second valve assembly comprises first and second valve members having first and second axial flow paths, respectively, said first valve member being operatively connected to said mandrel for rotation therewith, said second valve member being fixed, rotation of said first valve member varying the alignment of said first and second openings between a minimum open area and a maximum open area to permit an intermittently fluid flow pulse through said second end of said housing.

12. The apparatus of claim 11, wherein said second axial flow opening in said second valve member is generally crescent shaped when viewed in plan view.

13. The apparatus of claim 12, wherein said generally crescent shaped opening forms the mouth of a passageway extending through said second valve member, said second valve member comprising a disc shaped plate having an upper surface proximal said first valve member.

14. The apparatus of claim 13, wherein said first valve member comprises a second disc shaped plate.

15. The apparatus of claim 13, wherein said second valve mandrel comprises a disc shaped plate.

16. The apparatus of claim 11, wherein there is a terminal turbine stage comprising a terminal rotor assembly fixed to said housing and having a central bore therethrough, said mandrel extending through said central bore of said terminal stator body and a terminal stator assembly, said terminal stator assembly being operatively connected to the second end of said mandrel.

17. A turbine assembly comprising:
a tubular housing having a first end and a second end;
a valve assembly positioned in said housing proximal said first end;
a first turbine stage positioned in said housing between said first valve assembly and said second end of said housing, said first turbine stage having a first axial flow path and a first annular flow path;
a second turbine stage positioned in said housing between said first turbine stage and said second end, said second turbine stage having a second axial fluid flow path and a second annular fluid flow path;
a tubular drive shaft connected to first and second rotor assemblies of said first and second turbine stages for rotation therewith, said drive shaft having an axially extending flowway therethrough, said first and second axial fluid flow paths and said axially extending flowway providing a central fluid flow path through said turbine;
said first valve assembly being movable from a first position wherein pressurized fluid introduced into said first end of said housing flows through said first annular fluid flow path and a second position wherein at least a portion of said pressurized fluid flowing through said first annular fluid flow path is diverted to said axial fluid flow path.

18. A downhole pulsing apparatus comprising:
an elongate tubular housing having a first upper end and a second lower end;
a first valve assembly positioned in said housing proximal said first end, said first valve assembly comprising:
a valve element reciprocally mounted in said housing for movement between a first axial position and a second axial position, said first valve assembly including a modulator, said modulator delaying movement of said valve element from said first position to said second position;
a first turbine stage comprising:
a first stator assembly positioned in said housing below said first valve assembly, said first stator assembly comprising a first stator body having a through bore, a first stator annular flow path being formed between said first stator body and said housing;
a first rotor assembly positioned in said housing below said first stator assembly, said first rotor assembly comprising a first rotor body having a first central flow path in open communication with said through bore and a first rotor annular flow path in open communication with said first stator annular flow path;
a tubular mandrel having a first end, a second end, and an axial passageway therethrough, said passageway being in open communication with said central flow path through said first rotor assembly, said first end of said mandrel being connected to said first rotor assembly for rotation therewith;
a second turbine stage positioned in said housing below said first turbine stage, said second turbine stage comprising a second stator body having a central bore therethrough, said second stator body being fixed to said housing, said second turbine stage further comprising a second rotor body having a central bore therethrough, said mandrel extending through said central bores in said second stator body and said second rotor body, said second rotor body being connected to said mandrel for rotation therewith;
a second valve assembly disposed in said housing and connected to said second end of said mandrel, said second valve assembly being movable between a first partially open position and a second fully open position in response to rotation of said mandrel,
whereby pressurized fluid acting on said valve element in said first axial position initially flows through said annular flow path of said first turbine stage, continued application of said pressurized fluid moving said valve element to said second axial position, thereby diverting at least a portion of said pressurized fluid flow from said annular flow path through said first turbine stage to said through bore through said first stator cavity.
